(19) United States
(12) Patent Application Publication
(10) Pub. No.: US 2003/0154269 A1
(43) Pub. Date: Aug. 14, 2003

(54) Method and system for quantitatively assessing computer network vulnerability

(76) Inventors: Matunda G. Nyanchama, Oakville (CA); Alexandre Lopyrev, Richmond Hill (CA); Robert J. Garigue, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/073,992

(22) Filed: Feb. 14, 2002

(51) Int. Cl. G06F 15/173

(52) U.S. Cl. 709/223

(57) ABSTRACT

A system and method for quantitatively assessing the vulnerability of a computer network, comprised of elementary network elements each having at least one host, to external attack. The method produces a quantitative assessment that is repeatable and can be compared to a quantitative assessment of a separate network to determine the relative vulnerability of the network. The quantitative assessment is a function of the quantitative assessment of each elementary network unit, which is derived by classifying each port on each host and subsequently determining a quantitative vulnerability rating for the elementary network unit in accordance with the classification of each port on each host.

### FIELD OF THE INVENTION

The present invention relates generally to quantitative assessment of security vulnerabilities. More particularly, the present invention relates to automated assessment and quantification of, or security risks associated with, the vulnerabilities of computer networks.

### BACKGROUND OF THE INVENTION

Computer networks are a collection of interconnected computers, linked together for the purposes of sharing resources such as printers, storage space and processing power, and allowing interaction between computers both within and without the network. Each computer on a network is also referred to as either a node or a host. Typically each computer can interact with other computers on the network. In many cases a computer network is connected to other computer networks to form an internet. This is the typical manner in which the Internet is designed. Allowing computers in a corporate network access to the Internet, or other such public networks, results in allowing other computers attached to the public network to have a degree of access to the various nodes on the corporate network. Clearly, allowing a large number of unknown users access to the data stored on a corporate network exposes the corporate network to the risk of data corruption, theft, or system unavailability all of which are highly undesirable. As a result, it is essential to secure a computer network from external users who should not have access to the network. Securing a computer network from external attack is a tradeoff between allowing a system to be accessible to valid users and inaccessible to malicious attackers. A system can easily be made secure from attack by eliminating the network's ability to communicate with other networks, however, this is clearly not an acceptable solution in most cases.

The security of a computer network can only be guaranteed if all potential interaction with users is prevented, i.e. malicious users will not have a chance while there is no opportunity for inadvertent security violation by authorized users. As mentioned above, to fully secure the network from interaction with malicious users connection to the external network must be eliminated, which severely limits the value of the network itself. Thus, for a system to be useable and functional a certain degree of vulnerability to attack is likely. The goal of network security is to minimize the vulnerability of a network, while maintaining access needed to meet legitimate use of the network.

The degree to which a network is vulnerable is related to the number of possible attacks against which it has not been secured. It should be noted that so long as the computer network is accessible, it cannot be completely secure. At best it will be secure against all known attack methodologies, but may be vulnerable to an as yet unidentified means of malicious penetration. Due to the interest in keeping critical systems running, and the requirement of these systems to have connections available to users, and possibly to a broader network, it is crucial to be able to evaluate a computer network on the basis of its vulnerability to attack, in a quantitative manner.

In a typical network, such as the Internet, a transport layer transmits data as packets, or more generally data units, also generically known as transport protocol data units (TPDU). The receiving transport entity receives the TPDU from the network layer, which handles the routing of the data. In a network such as the Internet, various processes or application programs can be configured to receive data from the transport entity. To facilitate the receipt of data for multiple processes or applications, it is common to employ data ports in the transport layer, so that TPDUs, intended for a particular service, can be identified by a port number. If a service or application program receives data on a particular port, the application or service is considered to be bound to the port. The availability of ports indicates the availability of a service, and in many cases individual ports have become associated with given services (e.g. port ‘80’ is typically reserved for hyper-text transfer protocol (http) servers).

Typically, attacks on a network prey on known flaws in services bound to available ports. For example, a malicious party can scan a network to determine ports that are open, and then attempt to attack the services on the open ports to gain access to the network using known exploits associated with the service. Alternatively, a malicious party, with access to a network, can scan ports associated with services, such as file transfer protocol (FTP) or telnet servers, and then attempt to employ a “packet sniffer” to discern userid and password information transmitted as plain text; these services transmit data in the clear, i.e. their data is NOT encrypted A third method of network attack is to covertly introduce a backdoor to a system through such methods as getting help of an inside party, or through malicious email scripting. These backdoors are typically assume port numbers that minimize the risk of interfering with an existing service and makes it hard to detect them. Typically, these backdoors could exist for a long time without system administrators being aware of their existence.

When a port is open, the application bound to it responds to all traffic directed to the port. This is considered to be the most dangerous state for a network, as traffic from any source is allowed to interact with the application. If no application is using a given port, any traffic destined for that port is dropped, making the system secure to attacks on that port. Such a port is considered closed. An intermediate port condition is a filtered port. A filtered port responds only to requests from an address recognized as emanating from a trusted party. This is considered to be a safe practice, but it should be noted that if a number of computers running different services all employ filtering, a web of trust is created, allowing users inside this trusted circle access to other computers. This web of trust is only as secure as its least secure member, since a malicious attacker can gain access to all of the computers in the trusted circle by accessing the least secure member.

Despite the fact that it is generally considered to be safer to close ports attached to unneeded services than to leave those services available, many computer networks are vulnerable to attack because unused services are still active, and have not been secured. In many cases services are installed by either applications or operating systems in a default installation, and they remain unused, unmaintained, and open to attack. In other cases, services cannot be removed without compromising the utility of a system. In many of these cases replacing an insecure service with a secure service, such as secure FTP (SFTP) instead of FTP, can reduce the vulnerability of the network to external attack.

Another common method of securing a network is to employ a gateway, so that only one computer on the network is directly accessible to the external network. This system typically acts as a firewall, and prevents malicious access to the other computers in the network. Firewalls typically allow only legitimate business-related services into an internal network. Additionally, firewalls are known to interrupt certain services, such as peer-to-peer network sharing between computers on either side of the firewall. Allowing such communication through a firewall is like “punching a hole” in a wall and hence introduces a degree of exposure to exploitation.

In a practical computing environment, every network has a degree of vulnerability. If a system is designed to serve users, and to communicate with outside services it can only be protected from known attacks. It will be readily apparent that the existence of an open port is in itself a liability, but the degree of vulnerability depends also on the security of the application running on the open port. Simply closing all ports may eliminate vulnerability, but it is the equivalent of unhooking the computer from the network, which provides security at the expense of utility.

The United States Federal Bureau of Investigation (FBI) and the System Administration Networking and Security (SANS) Institute are viewed as the pre-eminent sources of information regarding the top identified threats to networks. In general, most attacks on a computer network rely upon well known “exploits” that allow malicious parties to gain access to a node on a network, either by using scripted tools or manually exploiting the known vulnerability. Because most attacks are based on known exploits, the FBI and the SANS Institute are able to inform network administrators of possible attacks and ports that should be secured by maintaining a list of known security problems. Typically, the list of dangerous ports published by the two organization are arrived via industry consensus on the danger associated with the ports.

Currently, assessment of the vulnerability of a network to attack is provided by a system administrator utilizing a port scanner, such as nmap, and then cross checking the open ports deemed most dangerous, e.g. those listed on the SANS or FBI lists. After determining which ports on each computer are potentially vulnerable, the application bound to the port must be checked to see if it is vulnerable to the attack. In a standard TCP based network, each computer has 65,535 potential ports, each of which can be bound to a service. An open port that is not on the SANS or FBI lists is still a potential vulnerability, as there may be associated exploits that are not deemed to be as dangerous as those of the ports on the lists. It could also be used by a “Trojan horse” application designed to give access to the system to malicious parties. Thus an accounting for each of the 65,535 ports must be made. This is a time consuming task, and must be repeated on each computer in the network. The same service can be also provided by different applications, for example two different web server applications. The choice of web server application affects the vulnerability of a system, as each application has its own vulnerabilities. A list of open ports which does not include information about the type of service running on the port is not a sufficient tool with which to fully secure a network.

There are no known software applications, such that map all of a computer's applications to the ports to which they are bound. This would allow an administrator to identify open ports and services available on a network and allow investigation of the potential extent of exposure from the services available. Further, there are few tools that allow for the quantification of vulnerabilities present in a network and hence the associated quantification of the security risks within the network.

Typically, system administrators have to live with a degree of vulnerability in order to provide utility of the systems they manage. As mentioned earlier, it is not possible to secure systems against all attacks. At the present time there is no standard method for assessing the vulnerability of a system to attack based on services available other than the exhaustive port listing and risk list comparison. This time consuming method does not result in a quantitative result, but instead relies upon a qualitative assessment made by the administrator. Alternatively, so-called “white hat hackers”, who attack a system on behalf of its administrator are employed to test the system against typical attacks. Neither of these approaches provide a repeatable method of assessment that can be performed across an entire wide area network to allow a corporation or other such entity to enforce an overall quantitative security policy, nor can quantitative security assessments be made between networks.

It is, therefore, desirable to provide a method and system for quantitative analysis of the vulnerability of a computer network to attack. This method would quantify risk associated within open ports within an network, being an aggregation of risks associated with individual systems or nodes in the network.

### SUMMARY OF THE INVENTION

It is an object of the present invention to obviate or mitigate at least one disadvantage of previous methods for assessing the vulnerability of computer networks to malicious access. It is a particular object of the present invention, to provide a method for providing a quantitative assessment of the vulnerability of the computer network.

In a first aspect, the present invention provides a method of quantitatively assessing the vulnerability of an elementary network unit, which includes at least one host, in which the state of each port, and application bound thereto, is known. This method comprises the steps of first classifying each port on each host in the elementary network unit and subsequently determining a quantitative vulnerability rating for the elementary network unit in accordance with the classification of each port on each host in the elementary network unit.

In an embodiment of the present invention the step of classifying each port includes the determining, for each port, a network vulnerability rating, an application vulnerability rating and a port status rating. The step of determining a quantitative vulnerability rating for the elementary network unit includes determining, for each port, a port vulnerability rating as a function of the network vulnerability rating, the application vulnerability rating and the port status rating, and determining, for each host in the elementary network unit, a host vulnerability rating as a function of the determined port vulnerability rating for each port associated with the host, and finally determining the quantitative vulnerability rating for the elementary network unit as a function of the determined host vulnerability ratings for each host in the elementary network unit. In another embodiment of the first aspect of the present invention, the network vulnerability rating is determined by network protocol conventions regarding the assignment of ports. In alternate embodiments the application vulnerability rating is determined by a combination of the application, and version of the application, bound to the port, and the operating system associated with the application. In further embodiments the port status rating is determined by the state of each port, which is selected from open, closed and filtered.

In a further aspect, the present invention provides an application program for quantitatively assessing the vulnerability of a computer network based on the state of, and application bound to, each port received from a network scanning application, the computer network being logically grouped into at least one elementary network unit having at least one host. The application program has classification means for classifying each port on each host in the elementary network unit as well as means for determining a quantitative vulnerability rating for the elementary network unit in accordance with the classification of each port on each host in the elementary network unit.

In embodiments of the application program of the present invention, the classification means includes means for determining a network vulnerability rating for each port, means for determining an application vulnerability rating for each port and means for determining a port status rating for each port. In other embodiments of the present aspect of the invention, the means for determining a quantitative vulnerability rating for the elementary network unit includes means for determining, for each port, a port vulnerability rating as a function of the network vulnerability rating, the application vulnerability rating and the port status rating, means for determining, for each host in the elementary network unit, a host vulnerability rating as a function of the determined port vulnerability rating for each port associated with the host and means for determining the quantitative vulnerability rating for the elementary network unit as a function of the determined host vulnerability ratings for each host in the elementary network unit.

Another aspect of the present invention provides a graphical representation for displaying computer network vulnerability. The graphical represetation provides a plot of the computer network divided into elementary network units, each elementary network unit having a quantitative vulnerability rating.

A further aspect of the present invention provides a method for evaluating risk in a computer network, the computer network having at least one elementary network unit. This method consists of the steps of determining a quantitative vulnerability rating for each elementary network unit and determining a risk associated with the computer network by in accordance with the determined quantitative vulnerability ratings. The step of determining the risk can include aggregating each determined quantitative vulnerability rating, and the step of determining the risk can include comparing the determined quantitative vulnerability ratings to benchmarks.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flow chart of a method of the present invention;

FIG. 2 is a flowchart of a method of the present invention;

FIG. 3 is a graphical risk map of an exemplary network generated in accordance with the present invention;

FIG. 4 is an Open Services Map of an exemplary network generated in accordance with the present invention; and

FIG. 5 is an Open Port Count Map of an exemplary network generated in accordance with the present invention.

### DETAILED DESCRIPTION

Generally, the present invention provides a method and system for quantitatively assessing the degree of vulnerability of a computer network to attack. It is common in the art to design computer networks so that the overall network is divided into a number of groups based on trust relationships, herein referred to as elementary network units (ENU). Each computer in a network has a set of trust rules that define how the computer will share its resources. Typically, a number of networked computers have similar rules of trust so that all the computers are able to share their resources freely. This interconnected trust relationship defines the ENU. Because of the trust relationship between computers in the ENU, gaining access to one of the computers can compromise the entire ENU. The size of an ENU can vary, depending upon the trust rules established. In some instances a single computer may be an ENU, while in others entire addressing subnets may form an ENU. The method of the present invention will be described in an embodiment where only a single ENU is evaluated. To evaluate the entire network, a series of ENUs would be scanned, in series or in parallel, and the associated vulnerabilities aggregated. Alternatively, it is possible to treat the entire network as an ENU and scan the entire network.

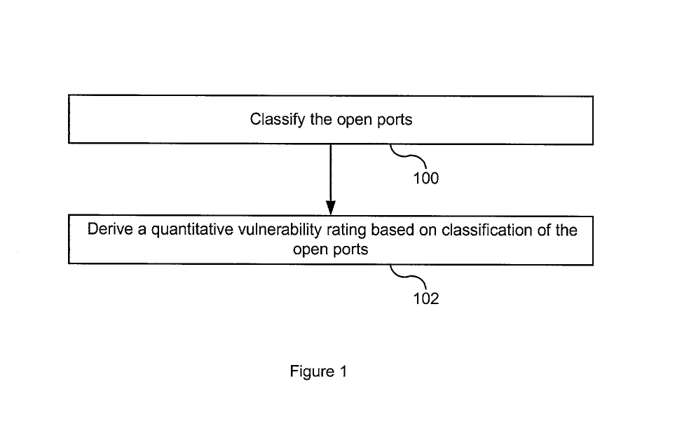

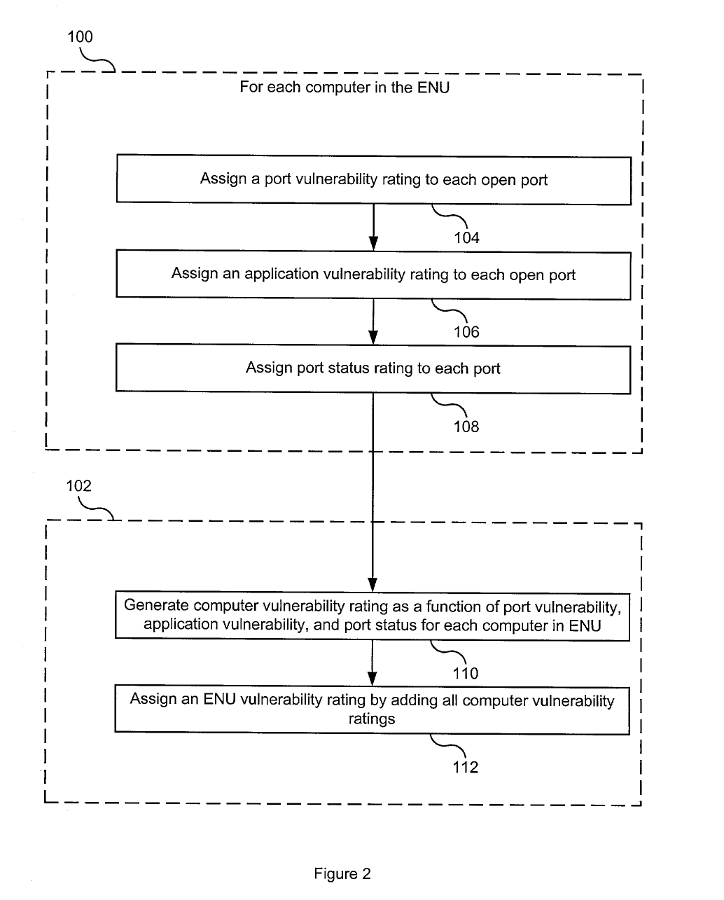

In general, the method of vulnerability assessment according to the present invention is illustrated in the flowchart of FIG. 1. Prior to commencing the process of evaluation of the vulnerability of the network each of the nodes in the ENU is scanned to determine the status of its ports and the applications or services bound thereto. In a network operating with a standard TCP stack, there are 61,535 ports per network node. The status of each port, as determined by the scan, is then used to classify each open port in step 100. This classification can be performed in a number of ways, as will be elaborated below. In step 102 a quantitative vulnerability rating of the ENU is calculated based on the classification of the open ports on each node of the ENU. The quantitative ENU vulnerability rating provides a numeric indication of the vulnerability of the ENU to attack. An exemplary method of deriving this numeric assessment is provided below in the description of FIG. 2.

FIG. 2 illustrates an embodiment of the present invention, where the classification of ports is performed to assign a vulnerability rating to each open port, a vulnerability rating to the application or service bound to each open port, and a port status to each port. The method commences after the scan of the ports for each computer in the ENU. Step 100 comprises three substeps, 104 106 and 108, that are performed on each computer in the ENU. The computers in the ENU can be evaluated in series, so that only one computer's ports are examined at a time, or they can be evaluated in parallel. For the sake of simplicity the embodiment of FIG. 2 shows a parallel implementation. In step 104 a network vulnerability rating is assigned to each open port. The networking vulnerability rating assigned to each open port varies on the basis of the risk of attack for that port in view of conventional or standard port assignments in the particular network protocol. For example, the likelihood of an attack on port ‘80’, which is used for http servers, is lower than the likelihood of an attack on port ‘8’, which is used for the echo command, so the port vulnerability rating will be lower for port ‘80’ than for port ‘8’ if they are both open.

In a presently preferred embodiment the network risk associated with each specific port, IPRiskₚₒᵣₜ_{_{—}}ᵢ is represented by a network vulnerability rating ranging from 0 to 1, where 0 means there is no possibility of the port being exploited and 1 is a guarantee of possible exploitation. In general, the network vulnerability rating associated with a port can be characterized as 0≦IPRiskₚₒᵣₜ_{_{—}}ᵢ≦1. For example, cleartext telnet (port ‘23’) or ftp traffic (port ‘21’) can be assigned a rating close to 1 since a “packet sniffer” in the network would be able to capture all text information relayed back and forth, resulting in an almost guaranteed exploitation. This can be characterized as IPRiskₚₒᵣₜ_{_{—}}_{ftp}=1.

In step 106, the application or service bound to the open port is assigned an application vulnerability rating. This application vulnerability rating, APRiskₚₒᵣₜ_{_{—}}ᵢ, is associated with a particular application, service or operating system and reflects that application, service or operating system's vulnerability. The application vulnerability rating can also be represented by a severity ranging from 0 to 1. A value of 0 indicates that there is no possibility of exploitation while 1 means a guarantee of possible exploitation. As in the previous step, this can be characterized as 0≦APRiskₚₒᵣₜ_{_{—}}ᵢ≦1. In the presently preferred embodiment this value is directly related to the operating system, operating system version, hardware platform, application and application version. As an example of the operating system affecting the application vulnerability rating, having NETBIOS ports ‘135-137’ opened on Windows™ and Linux platforms can create different risks to a system, depending on whose implementation of the NETBIOS drivers is more secure. Additionally, different http servers would provide different application vulnerability ratings as one server could have more known exploits than another.

In step 108 a port status rating is assigned to each port. Currently, a port can have one of three states: open, closed or filtered. An open port responds to any request, a closed port responds to no request, while a filtered port responds only to addresses it has been instructed to reply to. Filtered status may mean that a firewall, filter, or other network device prevents unauthorized users from reaching the port, or it could indicate that the computer replies only to requests from a list of addresses when it receives a connection on the filtered port. Note that though filtering reduces the vulnerability of an open port, it is not as effective as a closed port and thus the filtered port is assigned a port status rating between an open port and a closed port. The port status rating PSₚₒᵣₜ_{_{—}}ᵢ is a three-state variable determined during the processing of the scan results:

$${PS}_{port\_i} = \{ \begin{matrix}0 & port = {}_{}^{``}{closed}{}_{}^{″} \\ < 1 & port {=}^{} {}_{}^{``}{filtered}{}_{}^{″} \\ 1 & port {=}^{``} {opened}^{″}\end{matrix}$$

In step 110 a risk function is generated for each computer in the ENU. In one embodiment of this method, each port is assigned a port vulnerability Riskₚₒᵣₜ_{_{—}}ᵢ determined as a function of PSₚₒᵣₜ_{_{—}}ᵢ, IPRiskₚₒᵣₜ_{_{—}}ᵢ, and APRiskₚₒᵣₜ_{_{—}}ᵢ. In a presently preferred embodiment, a host vulnerability rating (Host_Riskₕₒₛₜ_{_{—}}ⱼ) based on the port vulnerability for each port associated with the host computer can be computed as

$${Host\_Risk}_{host\_j} = {\sum }_{port\_i = 1}^{65535} {Risk}_{port\_i} .$$

In step 112 an ENU vulnerability rating is calculated on the basis of the host vulnerability ratings of each computer in the ENU. For an ENU the cumulative vulnerability is a function of the individual host vulnerabilities. In a presently preferred embodiment, for an ENU with n hosts, the ENU vulnerability value is the sum of the host vulnerability values, for all the computers in the ENU, plus some constant C:

$${ENU\_Risk}_{net\_i} = {\sum }_{host\_j = 1}^{n} {Host\_Risk}_{host\_j} + C .$$

This constant is typically environment specific and can be determined by such things as the nature of the nodes in the ENU and the data that they hold, as well as the nature and number of trust relationships defined in the network, since exploitation of a given host may lead to exploitation of more hosts.

In an exemplary embodiment of the method of the present invention, the network vulnerability rating is calculated by assigning 1 to all open and filtered ports, the application rating is calculated by assuming that all applications bound to open ports are equally vulnerable to attack and are thus assigned a vulnerability rating of 1, and all open and filtered ports are assigned a port status rating of 1, while closed ports are assigned a port status rating of zero. Thus the port vulnerability, calculated as a function of the network vulnerability rating, the application vulnerability rating, and the port status rating is a 1 for an open or filtered port, and a zero for a closed port. The hosts vulnerability rating, created by summing the port vulnerabilities over all ports, yields the number of open ports in the host, and the corresponding ENU vulnerability rating shows the number of open ports in the ENU. During this process, open or filtered ports, and the applications bound thereto, are grouped into broad categories, such that ports and applications that are very likely to be attacked are put in a high risk grouping, ports and applications that are subject to potential attack but are less likely to be attacked are put into a medium grouping, and open ports and applications that have no known exploit are categorized into a third grouping. In a presently preferred embodiment, the high risk grouping is designed to correspond to the ports and applications listed by the SANS Institute, the medium risk grouping corresponds to an internally maintained list of other known exploitable ports, and the third group is all the ports that are not covered in the previous two lists. The number of open ports, and applications bound thereto, in each grouping is tallied for each computer, resulting in a high, medium and low risk score for each computer. As will be apparent to one of skill in the art, a greater or lesser number of categories can be employed without departing from the invention. These scores can be summed across an ENU, and used to quantitatively assess the vulnerability of the ENU. One of skills in the art will readily appreciate that this method of grouping can be performed on the results of any method of the present invention, and is not limited to being applied to the binary scoring method described above. In embodiments where ports and applications are assigned values between 0 and 1 depending upon their vulnerability, and where filtered ports are assigned a value of 0 and 1, the host vulnerability rating will not reflect the number of open ports, nor will the ENU vulnerability rating reflect the number of ports in the ENU, but the above grouping method, will indicate which of the classifications is responsible for the greatest component of the ENU vulnerability rating.

A risk map of the network can be generated from the ENU vulnerability rating for each ENU in the network. The risk map can be presented as a table, or graphically. A typical risk map table, as shown below, lists each ENU, here defined as subnets, and shows the SANS, Internal and Unassigned vulnerability scores (e.g. high, medium and low):

| Subnet | SANS | Internal | Unassigned |
|---|---|---|---|
| xxx.43.9. | 1304 | 94 | 574 |
| xxx.168.66. | 1074 | 179 | 537 |
| xxx.39.39. | 306 | 51 | 336 |
| xxx.39.84. | 258 | 9 | 197 |
| xxx.168.177. | 248 | 6 | 81 |
| xxx.39.165. | 216 | 25 | 474 |
| xxx.168.68. | 208 | 112 | 260 |
| xxx.39.86. | 199 | 4 | 131 |
| xxx.39.24. | 195 | 66 | 130 |
| xxx.39.81. | 189 | 21 | 200 |
| xxx.39.160. | 180 | 5 | 114 |
| xxx.168.96. | 175 | 25 | 162 |
| xxx.39.139. | 173 | 9 | 197 |
| xxx.39.71. | 171 | 24 | 140 |

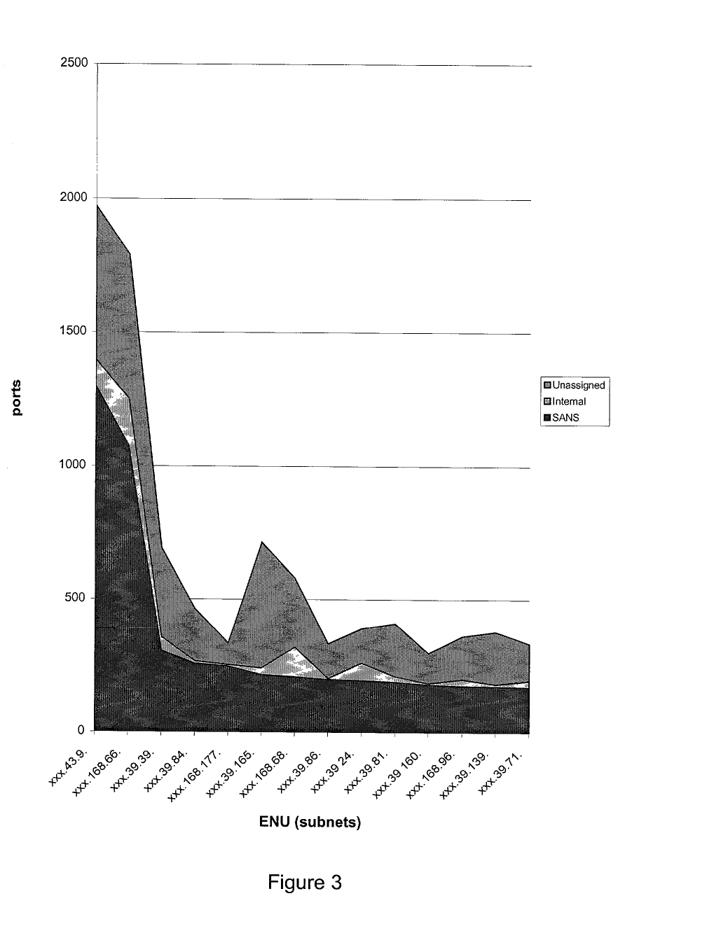

A risk map graph corresponding to the above table is illustrated in FIG. 3. The ENUs are ordered according to the high vulnerability (i.e. SANS) group scores. This representation provides a clear indication of the ENUs that are most vulnerable to attack.

Preferably, the network and application vulnerability ratings and the port status rating are standardized so that an assessment can be performed on different networks, and provide a useful comparison tool. It is contemplated that this standardized scoring system would be updated regularly to account for new application versions, and to account for newly discovered probable attacks. The basis for the scoring can, for example, be based on criteria such as the SANS Institute and FBI lists. Additionally, the quantitative scoring can be used to compare either ENUs, or overall networks to other comparable systems or to benchmarks. This provides an objective security target for a particular ENU or network that can be presented as a standard against which security will be measured.

The above-described method provides a numeric assessment of the vulnerability of a computer network on the basis of ENU security. The numeric assessment can be used in a number of ways to assist in determining the proper course for remedying the security vulnerabilities of the system.

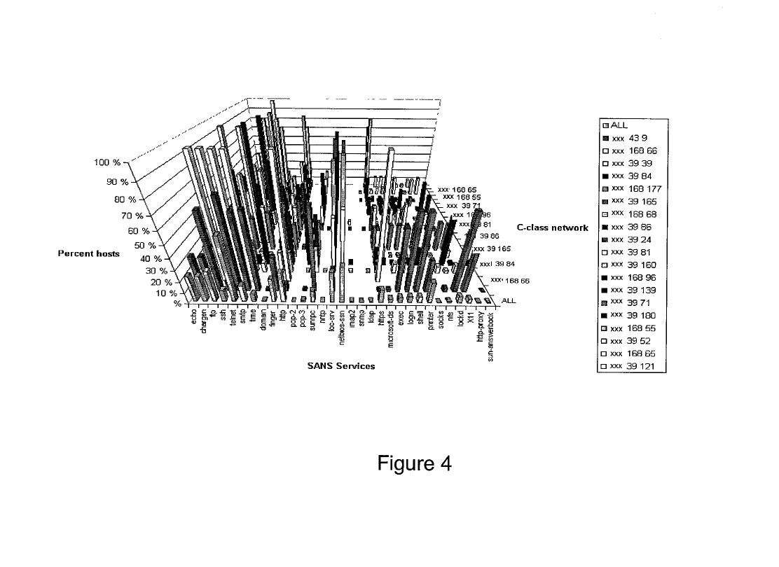

The numeric score can be used to generate an open services map as illustrated in FIG. 4. The Open Services Map is a plot showing the percentage of hosts in each ENU that have various services or applications bound to an open port. This provides an easy to understand report that illustrates which services and applications are available and may be liable to attack. Combining results from all ENUs within an organization gives an Open Services Map for the networks in the organization. In use, the Open Services Map may permit network administrators to recognize that a large percentage of computers in a given ENU are running services that they do not need to be running, and that make them more vulnerable to attack.

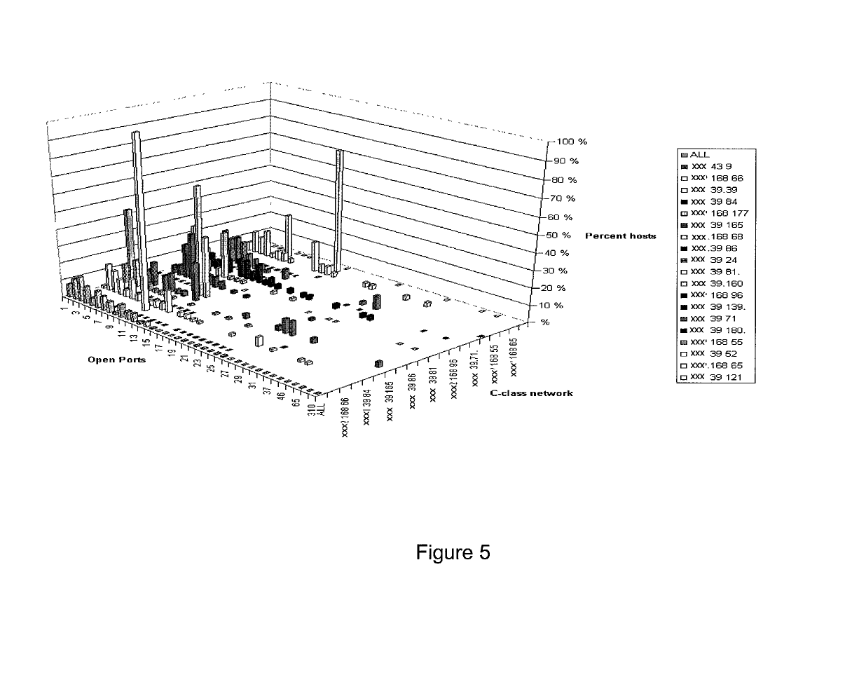

Additionally an Open Port Count Map can be generated to give a count of open ports present in a network. Such a map is illustrated in FIG. 5. This graph indicates the percentage of computers in each ENU that have various ports open. The ports that are presented in the Open Port Count Map can be varied so as to show only the ports that are listed by the SANS Institute, or only the internally derived list's ports. This allows network administrators to isolate the ENUs that are the most vulnerable and work to reduce their vulnerability.

Both the Open Services and the Open Port Count Maps provide an easy to understand view of the network that illustrates the vulnerability of the ENU to attack. They also provide a quantitative vulnerability value. The Maps can be generated at regular intervals to allow comparison of the vulnerability values over time to judge progress, and to illustrate which ENUs are the most vulnerable, and which services and ports are making them so vulnerable.

Whether displayed in tabular or graphical form, the results of the quantitative vulnerability assessment of the present invention permit managers and other to make determinations concerning the most appropriate targeting of resources to remedy security concerns within an organization. Such quantitative assessments also provide managers with a tool for comparing the security risks between networks or ENUs in an organization, or between organizations. Inter-organization comparisons permit entities such as insurers and actuaries to quantitatively assess the risks associated with disparate networks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of quantitatively assessing the vulnerability of an elementary network unit, including at least one host, in which the state of, and application bound to, each port is known, the method comprising:
classifying each port on each host in the elementary network unit; and
determining a quantitative vulnerability rating for the elementary network unit in accordance with the classification of each port on each host in the elementary network unit.

2. The method of claim 1, wherein classifying each port includes:
determining a network vulnerability rating for each port;
determining an application vulnerability rating for each port; and
determining a port status rating for each port.

3. The method of claim 2, wherein the network vulnerability rating is derived from the status of each port, and the application bound to it.

4. The method of claim 2, wherein determining the quantitative vulnerability rating for the elementary network unit includes:
determining, for each port, a port vulnerability rating as a function of the network vulnerability rating, the application vulnerability rating and the port status rating;
determining, for each host in the elementary network unit, a host vulnerability rating as a function of the port vulnerability rating for each port associated with the host; and
determining the quantitative vulnerability rating for the elementary network unit as a function of the determined host vulnerability ratings for each host in the elementary network unit.

5. The method of claim 2, wherein the network vulnerability rating is determined by network protocol conventions regarding the assignment of ports.

6. The method of claim 2, wherein the application vulnerability rating is determined by the application bound to the port.

7. The method of claim 6, wherein the application vulnerability rating is further determined by a version of the application.

8. The method of claim 6, wherein the application vulnerability rating is further determined by an operating system associated with the application.

9. The method of claim 2, wherein the port status rating is determined by the state of the port.

10. The method of claim 9, wherein the state of the port is selected from open, closed and filtered.

11. A application program for quantitatively assessing the vulnerability of a computer network based on the state of, and application bound to, each port received from a network scanning application, the computer network being logically grouped into at least one elementary network unit having at least one host, comprising:
classification means for classifying each port on each host in the elementary network unit; and
means for determining a quantitative vulnerability rating for the elementary network unit in accordance with the classification of each port on each host in the elementary network unit.

12. The application program of claim 11, wherein the classification means includes means for determining a network vulnerability rating for each port; means for determining an application vulnerability rating for each port; and means for determining a port status rating for each port.

13. The application program of claim 12, wherein the means for determining a quantitative vulnerability rating for the elementary network unit includes:
means for determining, for each port, a port vulnerability rating as a function of the network vulnerability rating, the application vulnerability rating and the port status rating;
means for determining, for each host in the elementary network unit, a host vulnerability rating as a function of the port vulnerability rating for each port associated with the host; and
means for determining the quantitative vulnerability rating for the elementary network unit as a function of the host vulnerability rating for each host in the elementary network unit.

14. A graphical representation for displaying computer network vulnerability, comprising:
a plot of the computer network divided into elementary network units, each elementary network unit having a quantitative vulnerability rating.

15. A method for evaluating risk in a computer network, the computer network having at least one elementary network unit, comprising:
determining a quantitative vulnerability rating for each elementary network unit;
determining a risk associated with the computer network as a function of the quantitative vulnerability rating.

16. The method of claim 15, wherein determining the risk includes aggregating the quantitative vulnerability rating for each elementary network unit.

17. The method of claim 15, wherein determining the risk includes comparing the quantitative vulnerability rating of the elementary network unit to a benchmark.

18. The method of claim 15, wherein determining the risk includes comparing the quantitative vulnerability rating of the network to a benchmark.

19. The method of claim 1 wherein the application is a service.
